(19) United States
(12) Patent Application Publication
(10) Pub. No.: US 2024/0313821 A1
(43) Pub. Date: Sep. 19, 2024

(54) COMPOSITIONS AND METHODS TO COAT A SUBSTRATE TO TREAT PASSIVE INTERMODULATION INTERFERENCE (PIM)

(71) Applicant: Delcomm, LLC, Southington, CT (US)

(72) Inventors: David R. Elliott, Southington, CT (US); Gary Santoro, Middlebury, CT (US); Manoj Kurubur Venkateshappa, Southington, CT (US)

(21) Appl. No.: 18/605,633

(22) Filed: Mar. 14, 2024

Related U.S. Application Data
(60) Provisional application No. 63/452,787, filed on Mar. 17, 2023.

(51) Int. Cl. H04B 1/525; B05D 1/18; C09D 177/00; H04B 1/10

(52) U.S. Cl. CPC H04B 1/525; B05D 1/18; C09D 177/00; H04B 1/10

(57) ABSTRACT

The invention describes a method and coated products that reduce, eliminate or prevent passive intermodulation interference with or between telecommunication components.

### CROSS REFERENCE TO RELATED APPLICATIONS

This application claims priority to U.S. Provisional Application No. 63/452,787, filed Mar. 17, 2023 and entitled COMPOSITIONS AND METHODS TO COAT A SUBSTRATE TO TREAT PASSIVE INTERMODULATION INTERFERENCE (PIM), the entire content of which is incorporated herein by reference for all purposes.

### FIELD OF THE INVENTION

The embodiments described herein generally relate to parts coated with nylon that are used in cellular towers or base stations. The coated parts prevent, reduce or eliminate passive intermodulation interference (PIM) between components within the cell tower or base station.

### BACKGROUND OF THE INVENTION

Passive intermodulation interference (PIM) is the generation of interfering signals caused by nonlinearities in the mechanical components of a wireless system. Two signals mix together (amplitude modulation) to produce sum and difference signals and products within the same band, causing the unwanted interference.

PIM effects can occur as the result of a non-linearity being experienced by two or more signals. A whole variety of instances can give rise to a non-linearity that can cause PIM effects. Some of the more common ones include: Joints where dissimilar metals meet and oxidation, etc.

Mechanisms for generating PIM interference in microwave passive components and systems include metallic contact nonlinearity, which can be avoided by selecting appropriate materials, and material nonlinearity, which is commonly present in various microwave passive structures.

As an example, in high-power microwave and antenna systems, electromagnetic signals are often required to pass through a filter after being subjected to power amplification so as to further filter out noise waves, and if the filter generates PIM, PIM products can be mixed into the whole system to form interference. Furthermore, in a system, the PIM performance of filters on a high power path, such as transmission filters, load filters, etc., has a decisive influence on the detection capability of the entire system.

Therefore, a need exists for an approach that overcomes one or more of the current disadvantages noted above.

### BRIEF SUMMARY OF THE INVENTION

The present embodiments described herein surprisingly provide a method and compositions that reduce, prevent or eliminate PIM that is associated with cell towers, base stations, snap-in hangers, antenna mounts, antenna backing plates, remote radio mounts, crossover plates and angles, pipe to pipe clamps, cluster support brackets, snap-in and standoff adapters.

The approaches described herein are advantageous to reduce, prevent or eliminate PIM with straightforward, efficient and cost effective coatings on substrates used in the telecommunications field.

In one aspect, methods are provided to prevent, reduce or eliminate passive intermodulation interference (PIM) associated with an apparatus. The method includes coating a substrate with a nylon material, wherein passive intermodulation interference associated with the apparatus is prevented, reduced or eliminated. Thus, the approach is straight forward and cost efficient due to the costs of nylon and simple coating process. The resulting coated substrate provides for the elimination, reduction or prevention of PIM. A suitable nylon material is known in the art as “nylon 11”.

Suitable pass ranges for PIM from the coated substrates described herein is from about −150 dBc to about −500 dBc, from about −160 dBc to about −190 dBc, from about −170 dBc to about −180 dBc and all ranges and values between −150 dBc to about −500 dBc, e.g., −151, −152, −153, −154, −155 through −198, −199, etc. and through −500 dBc.

In an aspect, a clean substrate is heated above the melting point of nylon and is contacted (dipped, sprayed, rolled, etc.) with the nylon such that a coating of nylon is affected. The coated substrate is then cooled such that the nylon coating fuses and/or adheres to the substrate. Special adhesion promoters are not required to effect the coating to the substrate, although adhesion promoters are optional.

In another aspect, an apparatus is provided that includes a substrate coated with a nylon, wherein the coated substrate reduces or eliminates passive intermodulation interference (PIM) associated with an apparatus. The substrate can be fully or partially coated depending on many factors, such as, where the coated substrate may be in contact or communication with another component of a cell tower or base station.

While multiple embodiments are disclosed, still other embodiments will become apparent to those skilled in the art from the following detailed description. As will be apparent, the embodiments are capable of modifications in various obvious aspects, all without departing from the spirit and scope of the present embodiments. Accordingly, the detailed descriptions are to be regarded as illustrative in nature and not restrictive.

### BRIEF DESCRIPTION OF THE DRAWINGS

FIG. 1 depicts a test procedure and apparatus configuration for PIM testing.

FIG. 2 provides PIM test results demonstrating that coated metal substrates with acceptable PIM values.

### DETAILED DESCRIPTION

In the specification and in the claims, the terms “including” and “comprising” are open-ended terms and should be interpreted to mean “including, but not limited to . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

In one aspect, methods are provided to prevent, reduce or eliminate passive intermodulation interference (PIM) associated with an apparatus. The method includes contacting, e.g., coating, a substrate with a nylon material, to provide a coated substrate, wherein passive intermodulation interference associated with the apparatus is prevented, reduced or eliminated. The coated nylon substrate reduces, eliminates or prevents PIM from occurring in the apparatus. Thus, the approach is straight forward and cost efficient due to the costs of nylon and a simple coating process. The resulting coated substrate provides for the elimination, reduction or prevention of PIM. A suitable nylon material is known in the art as “nylon 11”.

The process to coat a substrate is straight forward. A clean substrate is heated to a temperature above the melting point of nylon, generally greater than about 375° F. The heated substrate is contacted with the nylon and the nylon melts and coats the substrate. The heated substrate/nylon can remain in contact for a period of time, generally from about 1 second to about one minute to have the nylon adhere and coat to the substrate. Once the substrate is coated, the coated substrate can then be removed from the excess nylon (contained in a tank or container) and cooled.

In one aspect, the coated substrate/nylon coating is subsequently heated in a second step to at least 375° F. to ensure adhesion to the substrate surface and/or fuse the coating to the substrate. The adhesion/fusing step may be considered a second step or a continuation of the first coating step wherein the nylon and substrate are heated after the initial coating.

Not to be limited by theory, it is believed that the coating to the substrate adheres to the surface via one or more physical interactions between the coating and the substrate, including but not limited to, fusion, adhesion, covalent bonding, and/or ionic bonding. The coating is attached to the substrate surface in such a manner that it is not easily removed by abrasion, moisture, and/or handling during installation or maintenance.

In another aspect, the nylon and substrate are heated together, above the melting point of the nylon, e.g., about 700° F., and are contacted for a period of time from about 1 second to about 1 minute and then removed to cool.

The coated substrate is cooled while the nylon sets, fuses and/or adheres to the substrate surface. The entirety of the substrate can be coated or only select portions of the substrate can be coated. The choice is dictated by what portions of the substrate may come in contact with other components of a telecommunications system.

In one aspect, the substrate can be heated from about 375° F. to about 800° F., in particular, from about 400° F. to about 750° F., more particularly from about 450° F. to about 700° F. and even more particularly from about 500° F. to about 650° F., and all ranges and values between 375° F. to about 800° F., e.g., 700° F. These temperature ranges are applicable to both the initial coating step as well as the adhesion/fusing step.

Prior to contacting the heated substrate with the nylon, the substrate should be free of grease, oils, burrs, dirt and/or rust. Thus, the substrate surface may need cleaning prior to treatment with the nylon. This can be accomplished by brushing and/or heating the substrate to a point where all unwanted material is burned from the substrate surface. Alternatively, the substrate can be cleaned with a cleaning solution.

A suitable cleaning solution can include one or more solvents including toluene, ethanol, xylene, butanone, cyclohexanone, propyl acetate, propan-2-ol, butan-1-ol and mixtures thereof. A suitable cleaning solution, for example, is commercially available from AkzoNobel (7P-0200 Corvel Primer; product code 8135450).

The cleaning solution can further include a diluent such as, for example but not limited to, methyl ethyl ketone.

After the substrate has been coated with the nylon, the coated substrate is allowed to cool to ambient temperatures. Cooling can be effected by simply allowing the coated substrate to cool over time, or it could be subjected to cooling via a fan or by subjecting the coated substrate to a cold room, or quenching the coated substrate in water. Any suitable method to allow the coated substrate to cool is contemplated.

Nylons are known in the art. For example suitable nylons include nylon 1,6; nylon 4,6; nylon 510; nylon 6; nylon 6,6 (nylon 66), nylon 11 and nylon 12. Nylons can be synthesized from dinitriles using acid catalysis, butadiene or from lauolactam. For example, one method is applicable for preparing nylon 1,6 from adiponitrile, formaldehyde, and water.

Nylon 11 is prepared from castor beans that includes 11-aminoundecanoic acid that is polymerized into the nylon. A suitable nylon 11 material is commercially available from Arkema, RILSAN® MC Black 820 MAC.

Nylon 11 is also known as polyamide 11, PA11, poly(ω-undecanamide, or poly(undecano-11-lactam) has a melting point of 190° C. (374° F.) and a molecular weight of about 550.

The coating material, e.g., nylon, can further include additives, including but not limited to, antioxidants, plasticizers, slip modification agents, adhesion promoters, etc. Further, the coating can be a combination of two or more nylon materials, optionally, in combination with additives.

Typically, the coating on the surface of the substrate is deposited wherein coating thickness is approximately from about 10 mils to about 25 mils in thickness. A “mil” is a thousandth of an inch (0.001 inch). Suitable ranges include, for example, 10 mils to 20 mils, 12 mils to 18 mils, 14 mils to 16 mils and all ranges and values between 10 mils and 25 mils.

Suitable substrates are various metals utilized in the telecommunications industry and include, but are not limited to, various stainless steels or hot dip galvanized steels.

The substrates can be utilized for components utilized in the telecommunications industry such as a snap-in hanger, an antenna mount, an antenna backing plate, a remote radio mount, a crossover plate and angle, a pipe to pipe clamp, a cluster support bracket, a snap-in or standoff adapter.

The following paragraphs enumerated consecutively from 1 through 47 provide for various aspects of the present invention. In one embodiment, in a first paragraph (1), the present invention provides a method to prevent, reduce or eliminate passive intermodulation interference (PIM) associated with an apparatus comprising the step:
coating a substrate with a nylon material, wherein passive intermodulation interference associated with the apparatus is prevented, reduced or eliminated.

2. The method according to paragraph 1, comprising a first heating step wherein the substrate is heated to a temperature from above the melting point of the nylon to about 800° F. and then contacted with the nylon material resulting in a coated substrate.

3. The method according to paragraph 2, wherein in the first heating step, the substrate is heated to a temperature of between about 375° F. to about 800° F. and then contacted with the nylon material resulting in a coated substrate.

4. The method according to paragraph 3, wherein in the first heating step, the substrate is heated to a temperature of between about 600° F. to about 800° F. and then contacted with the nylon material resulting in a coated substrate.

5. The method according to paragraph 4, wherein in the first heating step, the substrate is heated to a temperature of about 700° F. resulting in a coated substrate.

6. The method according to any of paragraphs 1 through 5, wherein in a second heating step, the coated substrate is heated to a temperature of between about 375° F. to about 800° F. to adhere the nylon to the substrate surface and/or fuse the nylon coating.

7. The method according to paragraph 6, wherein in the second heating step, the coated substrate is heated to a temperature of between about 375° F. to about 600° F. to adhere the nylon to the substrate surface and/or fuse the nylon coating.

8. The method according to paragraph 6, wherein in the second heating step, the coated substrate is heated to a temperature of between about 375° F. to about 500° F. to adhere the nylon to the substrate surface and/or fuse the nylon coating.

9. The method according to paragraph 6, wherein in the second heating step, the coated substrate is heated to a temperature of between about 375° F. to about 400° F. to adhere the nylon to the substrate surface and/or fuse the nylon coating.

10. The method according to any of paragraphs 1 through 9, wherein the first and second heating steps are combined into a single step.

11. The method according to any of paragraphs 1 through 10, wherein prior to the coating of the substrate, the substrate surface is first treated with a cleaning solution comprising one or more of toluene, ethanol, xylene, butanone, cyclohexanone, propyl acetate, propan-2-ol and/or butan-1-ol.

12. The method according to paragraph 11, wherein the cleaning solution further comprises methyl ethyl ketone.

13. The method according to any of paragraphs 1 through 10, wherein the substrate is first heated to a temperature to burn off any oil, dirt, grease or rust.

14. The method according to paragraph 13, wherein the temperature is from about 375° F. to about 800° F.

15. The method according to any of paragraphs 1 through 14, further comprising the step:
cooling the coated substrate to ambient conditions to provide a coated substrate.

16. The method according to paragraph 15, wherein the cooling step comprises cooling via a fan, subjecting the coated substrate to a cold room, or quenching the coated substrate in water.

17. The method according to any of paragraphs 1 through 16, wherein the substrate is a metal.

18. The method according to any of paragraphs 1 through 17, wherein the metal is a stainless steel or hot dip galvanized steel.

19. The method according to paragraph 18, wherein the substrate is a snap-in hanger, an antenna mount, an antenna backing plate, a remote radio mount, a crossover plate and angle, a pipe to pipe clamp, a cluster support bracket, a snap-in or standoff adapter.

20. The method according to any of paragraphs 1 through 19, wherein the nylon coating thickness is approximately 10 to about 25 mils.

21. The method according to any of paragraphs 1 through 20, wherein the nylon material is thermoplastic nylon 11.

22. The method according to paragraph 21, wherein the thermoplastic nylon 11 is derived from castor oil.

23. The method according to paragraph 21, wherein the nylon 11 is produced from the polymerization of 11-aminoundecanoic acid.

24. The method according to any of paragraphs 1 through 23, wherein the pass range for PIM of the coated substrate is from about −150 dBc to about −500 dBc.

25. An apparatus comprising a substrate coated with a nylon, wherein the coated substrate reduces or eliminates passive intermodulation interference (PIM) associated with an apparatus.

26. The apparatus according to paragraph 25, wherein the substrate is a metal.

27. The apparatus according to paragraph 26, wherein the metal is a stainless steel or hot dip galvanized steel.

28. The apparatus according to any of paragraphs 25 through 27, wherein the nylon coating thickness is approximately 10 to about 25 mils.

29. The apparatus according to any of paragraphs 25 through 28, wherein the substrate is a is a snap-in hanger, an antenna mount, an antenna backing plate, a remote radio mount, a crossover plate and angle, a pipe to pipe clamp, a cluster support bracket, a snap-in or standoff adapter.

30. The apparatus according to any of paragraphs 25 through 29, wherein the pass range for PIM of the coated substrate is from about −150 dBc to about −500 dBc.

31. A method to prevent, reduce or eliminate passive intermodulation interference (PIM) associated with an apparatus comprising the step:

contacting and coating a substrate with a nylon material, wherein passive intermodulation interference associated with the apparatus is prevented, reduced or eliminated, wherein

the substrate and nylon material is heated to a temperature from above the melting point of the nylon to about 700° F. resulting in a coated substrate.

32. The method according to paragraph 31, wherein the contact time between the heated nylon and the substrate is from about 1 second to about 1 minute.

33. The method according to paragraph 32, wherein the temperature of the heated nylon and heated substrate are both about 700° F.

34. The method according to any of paragraphs 31 through 33, wherein prior to the coating of the substrate, the substrate surface is first treated with a cleaning solution comprising one or more of toluene, ethanol, xylene, butanone, cyclohexanone, propyl acetate, propan-2-ol and/or butan-1-ol.

35. The method according to paragraph 34, wherein the cleaning solution further comprises methyl ethyl ketone.

36. The method according to any of paragraphs 31 through 35, wherein the substrate is first heated to a temperature to burn off any oil, dirt, grease or rust.

37. The method according to paragraph 36, wherein the temperature is from about 375° F. to about 800° F.

38. The method according to any of paragraphs 31 through 37, further comprising the step:

cooling the coated substrate to ambient conditions to provide a coated substrate.

39. The method according to paragraph 38, wherein the cooling step comprises cooling via a fan, subjecting the coated substrate to a cold room, or quenching the coated substrate in water.

40. The method according to any of paragraphs 31 through 39, wherein the substrate is a metal.

41. The method according to any of paragraphs 31 through 40, wherein the metal is a stainless steel or hot dip galvanized steel.

42. The method according to paragraph 41, wherein the substrate is a snap-in hanger, an antenna mount, an antenna backing plate, a remote radio mount, a crossover plate and angle, a pipe to pipe clamp, a cluster support bracket, a snap-in or standoff adapter.

43. The method according to any of paragraphs 31 through 42, wherein the nylon coating thickness is approximately 10 to about 25 mils.

44. The method according to any of paragraphs 31 through 43, wherein the nylon material is thermoplastic nylon 11.

45. The method according to paragraph 44, wherein the thermoplastic nylon 11 is derived from castor oil.

46. The method according to paragraph 45, wherein the nylon 11 is produced from the polymerization of 11-aminoundecanoic acid.

47. The method according to any of paragraphs 31 through 46, wherein the pass range for PIM of the coated substrate is from about −150 dBc to about −500 dBc.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Test Conditions:

Validate all test equipment

Use low intermodulation loads

Ensure the samples are properly prepped

Minimize the number of adapters

Ensure all connections are torqued to spec

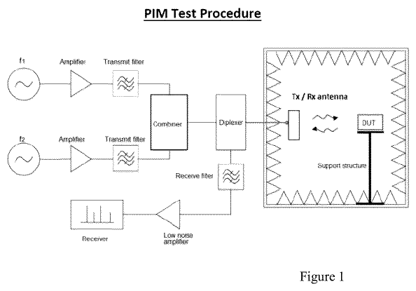

### Test Process: (See FIG. 1)

Mount the sample to a round or an angled member in the test chamber in the desired orientation.

Make sure samples are installed as per the installation instructions and torqued to specifications.

Once the setup is complete, two test signals are injected into the chamber.

If the test signals encounter a nonlinear junction, mixing occurs which generates PIM frequencies.

This PIM frequency is measured and compared to wireless service provider's specification (e.g., −150 dBc). Wireless service providers provide the maximum allowable PIM (e.g., −150 dBc) but can range from −150 dBc to −500 dBc, again depending upon the service provider's specifications and requirements.

If the initial PIM test results fall within the specifications proceed with dynamic testing.

Dynamic testing involves gently tapping all connector interfaces, mounted amplifiers, diplexers and antennas just enough to identify loose connections or mechanical discontinuities.

After tapping, use frequency sweep testing instead of testing individual frequency.

Repeat the test for various frequencies and sample orientation(s).

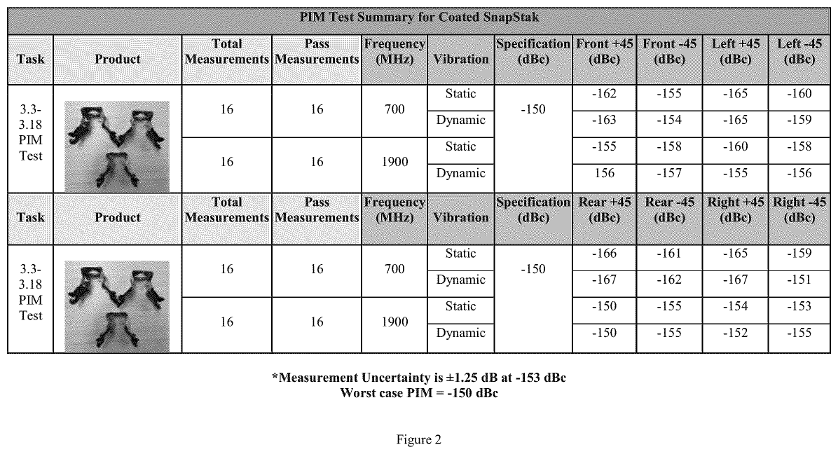

FIG. 2 provides test results demonstrating that coated metal substrates have acceptable PIM values.

The substrates are stackable snap-in hangers for ½ inch cable, stainless steel (item SHS12X). A clean metal substrate was heated to about 700° F. and contacted with nylon 11, held in a stainless steel holding tank. The heated metal substrate was held in contact with the nylon 11 for approximately 1 minute. The coated metal substrate was then removed and cooled to ambient temperature prior to undergoing any PIM testing. Coating thickness was about 10 to about 25 mils.

Test parameters includes 8 different orientations in the test chamber relative to an antenna with the worst result(s) as passing or not passing criteria. The eight positions were front +45 dBc, front −45 dBC, left +45 dBc, left −45 dBc as well as rear values noted in FIG. 2.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A method to prevent, reduce or eliminate passive intermodulation interference (PIM) associated with an apparatus comprising the step:
coating a substrate with a nylon material, wherein passive intermodulation interference associated with the apparatus is prevented, reduced or eliminated.

2. The method according to claim 1, comprising a heating step wherein the substrate is heated to a temperature from above the melting point of the nylon to about 800° F. and then contacted with the nylon material resulting in a coated substrate.

3. The method according to claim 2, wherein in the heating step, the substrate is heated to a temperature of between about 375° F. to about 800° F. and then contacted with the nylon material resulting in a coated substrate.

4. The method according to claim 3, wherein in the temperature of the heated substrate is about 700° F.

5. The method according to claim 1, wherein the substrate is first heated to a temperature to burn off any oil, dirt, grease or rust.

6. The method according to claim 5, wherein the substrate is heated from about 375° F. to about 800° F.

7. The method according to claim 1, where is the substrate is a metal and the metal is a stainless steel or hot dip galvanized steel.

8. The method according to claim 1, wherein the nylon coating thickness is approximately 10 to about 25 mils.

9. The method according to claim 1, wherein the nylon material is thermoplastic nylon 11.

10. The method according to claim 1, wherein the pass range for PIM of the coated substrate is from about −150 dBc to about −500 dBc.

11. An apparatus comprising a substrate coated with a nylon, wherein the coated substrate reduces or eliminates passive intermodulation interference (PIM) associated with an apparatus.

12. The apparatus according to claim 11, wherein the substrate is a metal that is a stainless steel or a hot dip galvanized steel.

13. The apparatus according to claim 11, wherein the nylon coating thickness is approximately 10 to about 25 mils.

14. The apparatus according to claim 11, wherein the pass range for PIM of the coated substrate is from about −150 dBc to about −500 dBc.

15. A method to prevent, reduce or eliminate passive intermodulation interference (PIM) associated with an apparatus comprising the step:
contacting and coating a substrate with a nylon material, wherein passive intermodulation interference associated with the apparatus is prevented, reduced or eliminated, wherein
the substrate is heated to a temperature above the melting point of the nylon to about 700° F. resulting in a coated substrate.

16. The method according to claim 15, wherein the contact time between the heated substrate and nylon is from about 1 second to about 1 minute.

17. The method according to claim 16, wherein the substrate is heated to a temperature from about 375° F. to about 800° F. to burn off any oil, dirt, grease or rust.

18. The method according to claim 15, wherein the substrate is a metal that is a stainless steel or hot dip galvanized steel.

19. The method according to claim 15, wherein the nylon coating thickness is approximately 10 to about 25 mils.

20. The method according to claim 15, wherein the pass range for PIM of the coated substrate is from about −150 dBc to about −500 dBc.
